(19) United States
(12) Patent Application Publication
(10) Pub. No.: US 2005/0183031 A1
(43) Pub. Date: Aug. 18, 2005

(54) Document display method and apparatus

(76) Inventor: Robert Denzil Onslow, London (GB)

Correspondence Address: FLYNN THIEL BOUTELL & TANIS, P.C., 2026 RAMBLING ROAD, KALAMAZOO, MI, 49008-1699, US

(21) Appl. No.: 11/032,694

(22) Filed: Jan. 10, 2005

(30) Foreign Application Priority Data
Jan. 8, 2004 (GB) 0400354.7

(51) Int. Cl. G06F 3/00; G06F 17/24

(52) U.S. Cl. 715/805; 715/804; 715/808; 715/513; 715/501.1

(57) ABSTRACT

A method and apparatus for displaying documents, especially document images, in a computer environment is disclosed. A first ‘source’ document is displayed in a first application window 2. Regions of the document that are referred to in a second ‘target’ document, or which refer to the second target document, are highlighted by an on screen indication such as a rectangular box 7. When a user moves an on-screen pointing device into the region 7, a second window 8 may be displayed showing the region of the target document which is referred to, or which refers to the source document. Thus, only the specific part of the target document that is relevant to the highlighted region of the first document is displayed. The method and apparatus therefore allow the user to view only those parts of a document image that are pertinent.

This invention relates to the field of document display on a computer, particularly where the text of a first ‘source’ document refers to a second ‘target’ document, or where it is referred to in a target document. The invention has particular application to document images, because the documents are “fixed” and cannot be edited, however as will be seen below, the invention also has application to non-image documents such as word processing files.

Many software packages are available for displaying images of documents on a computer screen. For example Adobe Acrobat can display multi-page images of documents in the Portable Document Format (PDF); Windows Picture and Fax Viewer can display multi-page images in the Tagged Image Format (TIF), as well as a number of other image formats. When a user uses software of this type, a window is opened on the screen which shows the image of a particular page of the document, surrounded by a window frame, typically with a menu bar and a tool bar at the top, and a status bar at the bottom.

Many documents cross-refer to other documents, and are themselves referred to by other documents. It is of course well known in the field of non-image documents, for example Microsoft Word documents or HTML documents to use hyperlinks i.e. regions of the document as rendered on the screen which, when clicked with a pointing device, open a second document either in the same window or in a new window.

It is perhaps less common, albeit known, to have hypertext links appearing in a rendered image of a document in an image format. An example is provided by the applicant's own XBundle software, which adds hypertext links on the image of the displayed page, in the margin, adjacent a reference in the text to another document.

Equally, it is also known that a hypertext link should refer to a particular portion of another document, as distinct from the other document as a whole. For example, in the HTML format, it is possible to apply a label to a particular paragraph of text of the second document, and use that label in the hypertext link from the first document. Then, when the hypertext link is activated with the pointing device, the second document not only opens in a window, but scrolls down to the labelled paragraph.

In WO 01/55897, there is disclosed a “prebrowser” function, in which a pane showing a target document or other electronic resource is displayed over an HTML browser window when the mouse is moved over an HTML hyperlink pointing to the target document or electronic resource; the pane being removed when the mouse moves off the HTML hyperlink. The computer is adapted to display an image of the whole prebrowsed page, as a preview for the user.

A rather different, but nonetheless relevant for present purposes, field of presentation of information on a computer screen comes in the form of popup boxes containing comments or assistive text. For example, using the Open Office Word Processor, it is possible for users to add comments into the document, as distinct from entering textual content into the document, which relates to a particular paragraph of the document. This comment is displayed in a popup box when the pointing device hovers over a paragraph, or a part of the paragraph, to which a comment has been added. Typically the popup box is a plain, undecorated window, as distinct from the decorated window of the application itself.

### SUMMARY OF THE INVENTION

The present invention seeks to improve the presentation of cross-references between source and target documents.

Accordingly, in a first aspect of the invention there is provided a method of displaying one or more regions of one or more target documents which are referred to in, or refer to, at least one region of a source document, the method comprising (a) displaying the source document in a first window, (b) displaying at least one of the one or more target document regions in at least one second window when a pointer is within the said source document region, and (c) removing the displayed target document region or regions from the display when the pointer moves outside the source document region.

Alternatively, in a second aspect of the invention, the method comprises (a) displaying the source document in a first window, (b) displaying at least one of the one or more target document regions in at least one second window when a pointer is within the said source document region, the second window or windows partly overlapping the source document region; and (c) removing the target document region from the display when the pointer moves outside the source document region and is outside the second window or windows.

Alternatively, in a third aspect of the invention, the method comprises (a) displaying the source document in a first window, (b) displaying a control means which appears or is enabled only when the pointer is within the said source document region; (c) if the control means is activated by the pointer, displaying at least one of the one or more target document regions in at least one second window.

Preferably the method comprises causing the target document to replace the source document in the first window when the second window is clicked with a pointing device.

Preferably, where there are more than one target document regions, the system displays a list of the target document regions in a second window, the elements of the list being responsive to a mouse click so as to cause the respective target document region to be displayed in the second window; which list preferably includes text describing the relationship between each respective target document region and the source document region; more preferably the system displays one target document region in the second window and the said list of the other target document regions in the second window.

### BRIEF DESCRIPTION OF THE DRAWINGS

Preferred embodiments of the invention will now be described, by way of example, and with reference to the drawings in which:

FIGS. 1 to 3 show simulated screen displays of a system according to the invention;

FIG. 4 shows an XML file containing data suitable for use by a system according to the invention;

FIG. 5 shows a non-normative Document Type Definition (DTD) of the XML data in FIG. 4;

FIG. 6 shows a sequence diagram of an application according to the invention; and

FIG. 7 illustrates the interaction between the various computer hardware components when operating the system of the components.

### DETAILED DESCRIPTION OF THE PREFERRED EMBODIMENTS

A preferred embodiment of the invention will now be described with reference to the figures. The description will first indicate the functionality provided by the invention, and the manner in which a user can interact with and benefit from that functionality. The description will then indicate how the invention is implemented in terms of the software and hardware components of which it is comprised.

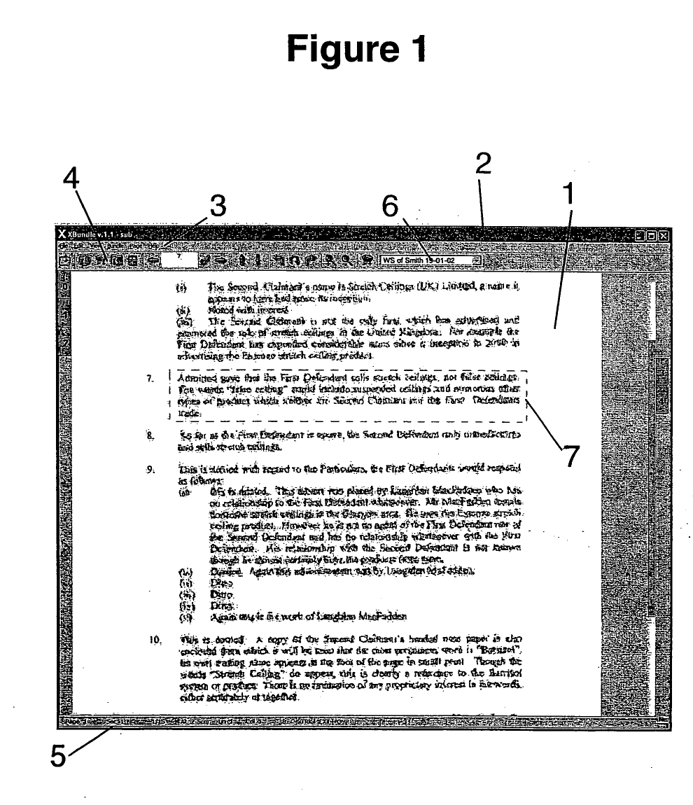

In FIG. 1, there is shown a page 1 of a document in an application window 2 with menu bar 3, tool bar 4 and status bar 5. Preferably, the application window is implemented as part of a browser program enabling access to document files preferably stored in a database on a local network, or on a distributed network such as the Internet. The implementation of such a browser or such application windows is well known to those skilled in the art, and so is not discussed here in any detail.

The name and date of the document is displayed in the drop down box 6. A dotted rectangle 7 is displayed around a particular paragraph of the document which, the rectangle indicates, has been referred to in a second target document, or which itself refers to a particular part of a second target document. The fact that this paragraph is so referred to in, or refers to, the second document has been manually entered into a record, for example a database or XML file which the application is configured to access, alternatively the record may be part of the in the electronic file which forms the first document.

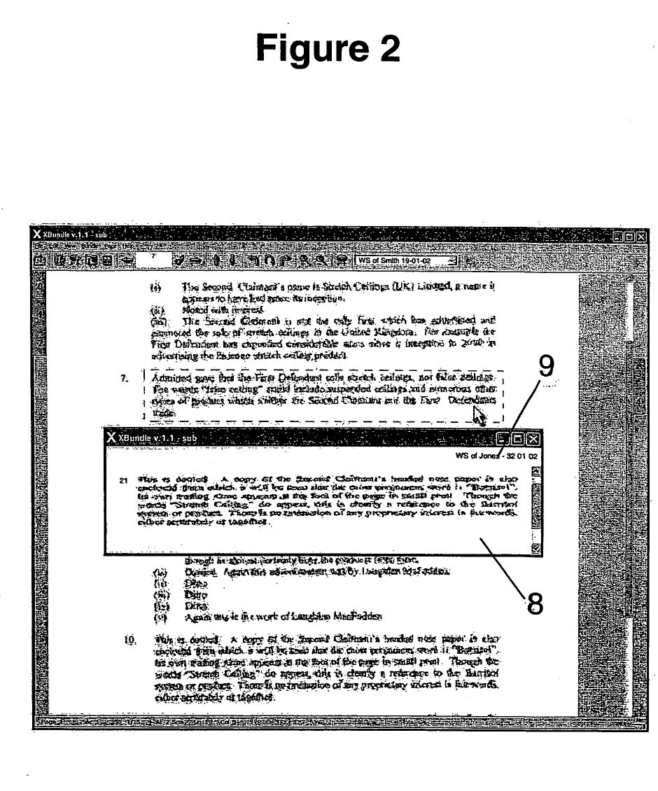

FIG. 2 illustrates what happens when a user moves the pointing device, e.g. the mouse pointer, into the region 7. As can be seen, the application is operable, such that when the pointing device moves into the region 7, it opens a relatively undecorated popup window 8 on top of the application window 2. Within the popup window is displayed the region of the second document which refers to the content of the region 7 in the first document, e.g. a discussion, comment or criticism of the same, alternatively a region of the second document which is referred to in the first document. If the user clicks within the popup window 8, the second document opens within the application window 2, replacing the first document in the window. The name of the second document is also shown in the popup window in a region 9 thereof.

As mentioned above, the reference itself is defined by an entry in a record. Thus, the semantic nature of the reference in the document in question is largely immaterial, and what references should and should not be linked may be left as a user choice.

In the preferred embodiment, an XML file is used as the record which defines the links between the source and target documents for the many electronic documents available for viewing. The application is configured to load the XML file at initialisation, and access the record when a document is selected for viewing to retrieve the relevant links and data so that the relevant regions of the target document can be displayed at the appropriate time.

Referring again to FIG. 2, if the user now clicks on the page 1 outside the region 7, the window 8 closes. Alternatively if the user moves the pointer to another link region on the page 1, the popup window 8 closes and a new popup window appears as is appropriate to that further region.

Another alternative embodiment to that shown in FIG. 2 is that the application opens the popup window so that it overlaps partly the region 7, and closes the popup window when the pointer moves outside the region 7, and is outside the popup window 8. This embodiment reduces the number of mouse clicks needed to delete unwanted popup windows from the display.

A yet further alternative embodiment is, instead of displaying a popup window 8 containing the image of the region 7 when the pointer is within the region 7, to display a control icon such as a popup button which, when activated by the pointer, causes the popup window 8 to appear on the screen, but which control icon is deactivated or removed when the pointer moves out of the region 7. By this means, the user is offered the opportunity to control whether the page 1 is to be partially obscured by the popup window 8. This also ensures that the user is not offered inappropriate controls while the pointer is outside the region 7. If the control icon is displayed in or adjacent to the region 7 while the pointer is within the region 7, and is not displayed or removed while the pointer is outside the region 7, this has the advantage of alerting the user to the existence of a link, while ensuring that the page 1 is kept clear of unnecessary items. The control icon could contain the text of the abstract of the link (see below), or could produce a popup box showing such text when the mouse hovers over the control.

By these means, a user viewing the first, source document is able to view the same in context i.e. immediately seeing other documents, or being notified of the existence of other documents, which discuss or comment upon the first. So for example, in the field of litigation support software, a paragraph of a witness statement or deposition which has been specifically commented upon in another witness statement or deposition, or in a transcript of court proceedings, can be read in the immediate context of the comments made in those other documents.

A very particular application of the invention in the field of litigation support software is to be found in its application to pleadings or case statements in which each paragraph of one party's pleading is pleaded to by a paragraph of another party's pleading e.g. a statement of defense. In turn, this paragraph is pleaded to by a paragraph of a third document, e.g. the first party's statement in reply. By using the invention, it is possible for the user viewing a paragraph of the case statement immediately to see what was said about that paragraph in the defense. If necessary, the user can also view the defense and immediately see what was said about that paragraph in the defense in the statement in reply. By this means, it is possible to click through, not only a chain of documents, but a chain of specific issues contained within the documents. This feature of the ability to click through documents gives rise to the word “infralink”, which is the word which will be used hereafter to denote the type of link described herein.

Another application of this chain aspect of the invention, again in the field of litigation support systems, is to legal judgments and decisions in which particular paragraphs of a first legal decision are discussed, applied, distinguished or disapproved in subsequent legal decisions. By applying the invention, it is possible for the user to follow the chain of reasoning on a particular legal point through a line of legal decisions much more simply than by a manual process of looking up the citations of decisions which have referred to a particular decision of interest, and then using a book, or opening an electronic file, in order to view the subsequent decisions as a whole.

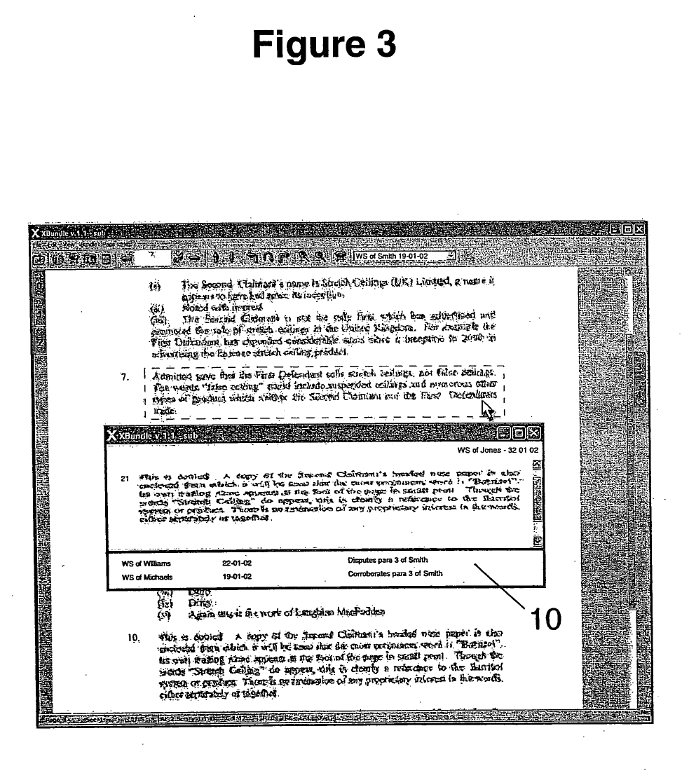

FIG. 3 shows how the preferred application is arranged to operate where there are several documents which refer to, or are referred to, by a first document. Although it would be possible to open multiple popup windows, this may well present the user with too much information. Hence it is preferred if a popup window is opened which displays a list 10 of document names, dates, and information such as abstract of the discussion or comments made. In this case, the application is arranged such that clicking on an entry in the list causes the popup window to fill with the image of the relevant part of the selected document. Alternatively, as shown in FIG. 3, the popup window can be implemented to display the image of one of the documents and a list of the other documents.

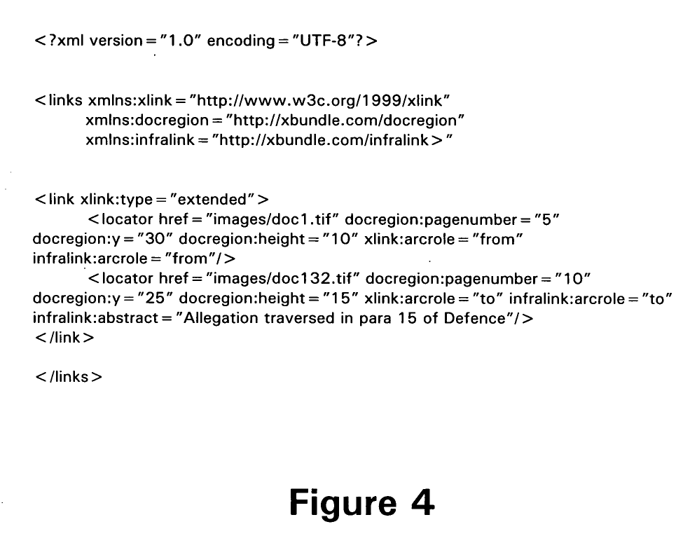

The implementation of the software and hardware components making up the invention will now be described in more detail with reference to FIGS. 4 to 7.

FIG. 4 illustrates an XML file which defines the infralinks from the document shown in FIG. 1. The infralink provides the necessary functionality and information to allow a region of a source and target document to be logically linked with each other. In the preferred embodiment, the XML file contains many definitions so that infralinks between a plurality of source and target documents can be formed, however in FIG. 4 only a single link is shown for clarity.

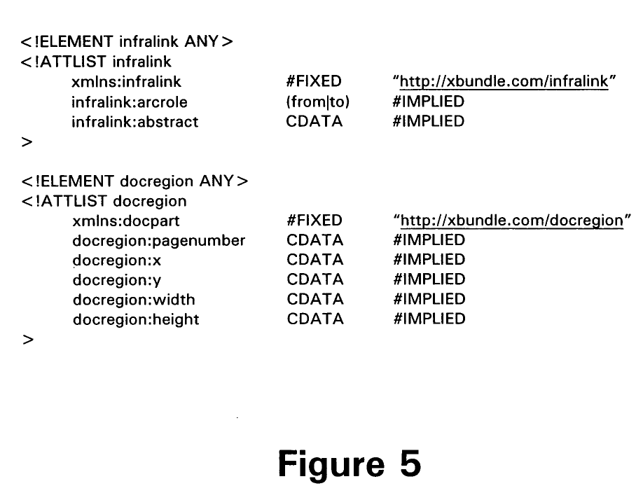

Two namespaces are grafted onto the XLink namespace (http://www.w3.org/1999/xlink). These are the docregion namespace (http://xbundle.com/docregion) and the infralink namespace (http://xbundle.com/infralink). The non-normative Document Type Definitions (DTDs) for these two specifications are shown in FIG. 5. The infralink namespace extends the xlink namespace specifically to denote a link of the type described herein, namely where a region of the target document is displayed when the pointing device is within the source region.

The root element of FIG. 4, shown in the third paragraph of the code, encloses a link element, which itself encloses xlink references from source documents to target documents. According to the XLink specification, setting an xlink:type attribute on any element to “extended” causes a requirement for locator sub-elements with a required href attribute. The embodiment of the invention grafts onto the locator element the three docregion attributes, docregion:pagenumber, docregion:y and docregion:height, which together define a region within the document with the hypertext reference href “images/doc1.tif”. According to the docregion specification, the docregion:y attribute defines the top left point of the region to be a certain percentage of the height of the page image below the top left corner of the image, and the docregion:height attribute defines the height of the region, again as a percentage of the page image height. The docregion:pagenumber attribute defines the page number in a multipage image format, or in a word processing file format.

This region so defined is set to surround a paragraph which has been discussed, commented on or which makes a reference to another document, in this case “images/doc123.tif”. In order to show that this xlink is an infralink, the attribute infralink:arcrole is set to either “from” or “to”, “from” if the document referred to by the href is the source of the infralink, and “to” if the document referred to by the href is the target of the infralink.

Next, a second locator element defines the target of the infralink. Href is set to the target document, namely “images/doc123.tif”, and docregion attributes are used to define a region within the second document where the discussion or comment on the first document is contained. The infralink:arcrole attribute is set to “to”. Further, an optional infralink:abstract attribute is provided which contains text summarising the discussion or comment which the second document region makes of the first document region i.e. describing the relationship therebetween. This is to enable the list seen in FIG. 3 where there are multiple target locators. (Only one target locator is shown in FIG. 4).

When the application in FIG. 1 is required to display a certain page of a document, it looks up any source infralinks corresponding to that page, either by retrieving the information from the file defining the document, or by retrieving the information from the record.

The application displays a dotted line around the region and is arranged such that when the pointing device hovers within the region, the image region defined by the target infralink is loaded and displayed in a popup window in a suitable location on the screen, as shown in FIG. 2. Or if there are multiple target regions, the application may display a list of target regions, together with the text contained in the infralink:abstract attribute, as in FIG. 3.

Although the specific embodiment described herein uses an XML file to define the table of infralinks for the first document, the invention can also be used with a database, or simply with data contained within the electronic file which is the first document. Also, although the invention has been described herein mainly by reference to document images, it will be immediately apparent that it can be used with plain text files, text files with formatting information such as word processing files, spreadsheet files, and XML files and such like. When used by non-image files, it may be preferable to store the infralink table within the electronic file which is the first document, rather than in a separate electronic file which refers to the first document.

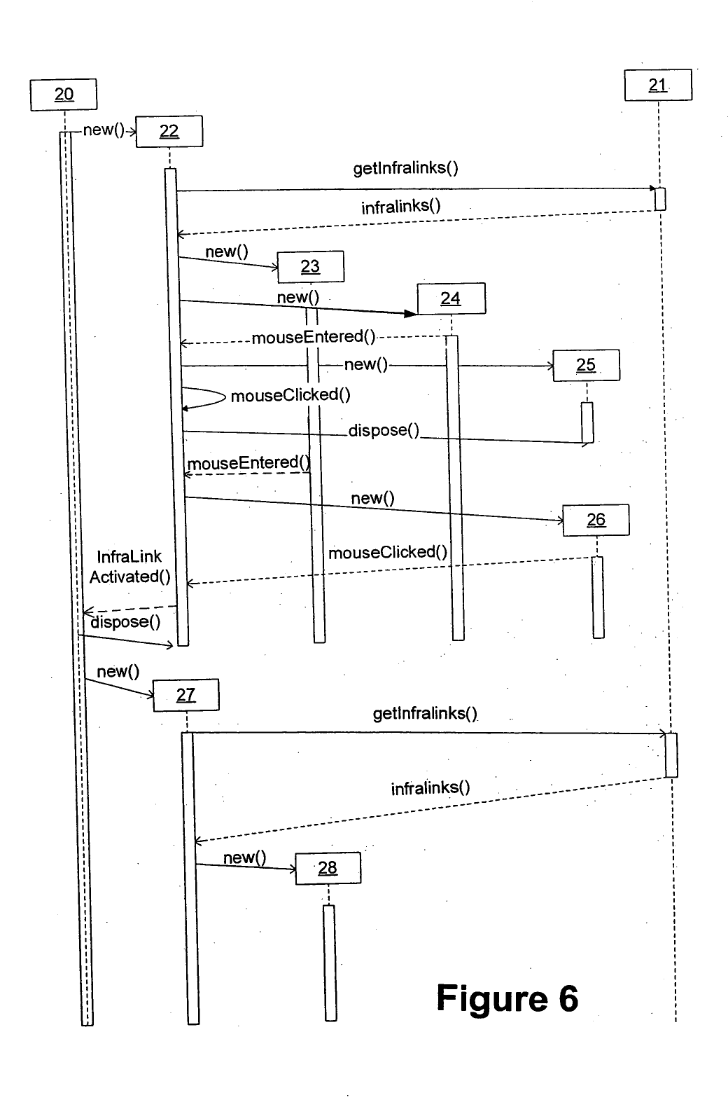

FIG. 6 shows a non-normative Universal Modelling Language (UML) sequence diagram of an application 20 according to the invention, illustrating the various processes that are carried out during operation.

The application first creates a viewing object 22, corresponding to the viewing window shown in FIGS. 1 to 3, in which a document page is displayed. The viewing object uses a lookup object 21, which is a process that obtains the infralinks present on the page being viewed from the record mentioned above. The lookup object creates a transparent overlay 23, 24 for each infralink on the page. The overlays fire mouse events to the viewing object every time a pointing device enters or exits the overlay. The viewing object 22 reacts to the mouse entered events by creating a popup window 25 which contains the part of the image which is the target of the infralink i.e. the part of the second document which discusses or comments upon the part of the first document over which the respective overlay 23, 24 lies. A mouse click received by the viewing object 22, but not by the overlays 23, 24 and not by the popup window 25, closes the popup window 25. Alternatively, a mouse event signifying that the mouse pointer has moved out of the overlay region may also be used to close the popup window.

In the example shown in FIG. 6, when the pointing device enters the overlay 23, a new popup window 26 is created, which is then shown as being clicked by the pointing device and sending a mouse clicked event to the viewing object 22. The viewing object 22 reacts by sending an infralink activated event to the application, which then disposes of the viewing object 20, and creates a new viewing object 27 which contains the second document which was the target of the infralink which was clicked. This second viewing object 27 then looks up the infralinks on the page from the lookup object 21, and creates an overlay 28 on the page for each infralink encountered.

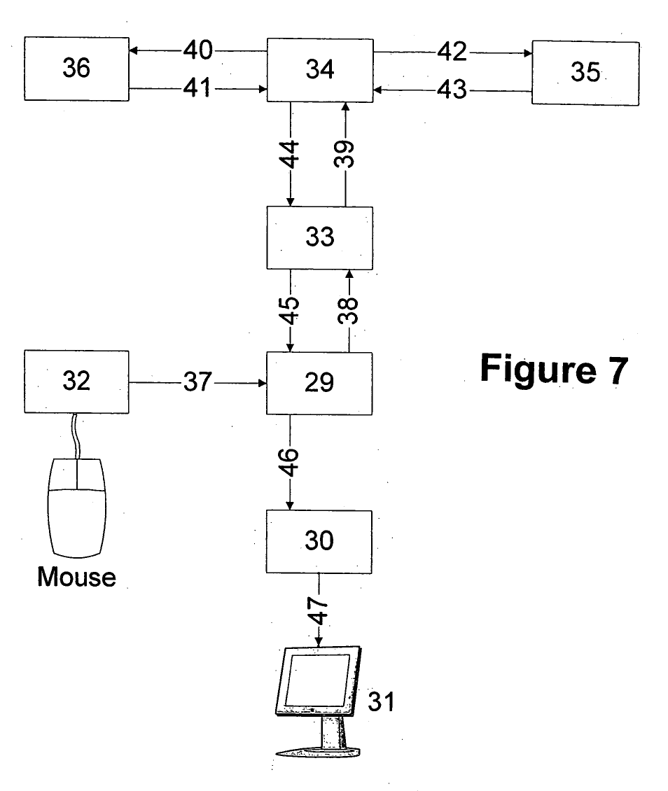

In FIG. 7 there is a schematic illustration of the main components of a computer system with the system the subject of the invention installed on it. A CPU 29 is connected to a video card 30. The CPU has a number of processes running on it which make up the operating system. The operating system controls the video card so as to paint windows, and the contents of windows, on a monitor, typically a flat LCD screen or cathode ray tube device. The CPU is also connected to an input/output card 32 which is connected to a mouse device. Movements of the mouse device are notified to the CPU by interrupt signals, and the values of the movements travel on the data bus into the CPU 29, as indicated by the data flow 37.

The position of the mouse is compared by the operating system with the coordinates of windows on the screen, and where the mouse is calculated to be within a particular window, a signal is sent to the computer program which generates the window. In the case of a window which is generated by the specific embodiment of the invention, using the Java programming language, the event is sent to the Java virtual machine 33, as shown by the data flow 38 (which is in fact like the operating system also running as a process on the CPU 29). The Java virtual machine 33 compares the positional data with the coordinates of the windows which it is responsible for having created, and generates a mouse movement event, shown by the data flow 39 which is best described as being received by the java computer program 34 which implements the system the subject of the invention (although in practice the java computer program 34 runs within the java virtual machine 33).

The computer program 34 compares the mouse position with any source document regions which are defined for the image of the document which the computer program has caused to be displayed on the monitor 31, and if the mouse position is within such a source document region, and if the mouse is hovering within that region, the program 34 sends a request signal 40 to a repository of infralinks (which in the particular embodiment described above, is a region of computer memory containing a representation of the XML elements described above) requesting the repository to transmit target infralink(s) defined for the source region in which the mouse is positioned. Those target infralinks are shown as being received by the computer program 34 by the data flow 41, which in turn causes the computer program to send a request signal 42 to an image repository (typically a part of the computer program which can acquire image data from permanent storage on the computer such as a hard drive) which returns image data denoted by the data flow 43. The image data is the image of the target document together with a border around the target document region defined by the target infralink(s).

In response to the acquisition of the image data, the program 34 issues an instruction 44 to the Java virtual machine to open a relatively undecorated window containing the image data, appropriately positioned relative to the source document region as previously described. This instruction is converted to an instruction to the operating system 45, which is executed by the CPU 29, causing signals to be sent to the display card 30, which issues appropriate control signals to the monitor 31. The user perceives the target document appearing in a relatively undecorated window overlapping the source document region.

Further mouse movements and mouse clicks from the input/output card 32 are sent in a similar manner to the CPU, through the operating system to the Java virtual machine 33, causing the program 34 to issue instructions to destroy the undecorated window (as the mouse moves out of the undecorated window) or to load the main window with the target document image (if the mouse is clicked within the undecorated window). These instructions travel in a like manner from the program 34 to the Java virtual machine 33, by means of the data flow 44 and are translated into instructions to the operating system to be executed on the CPU 29, such instructions being shown by the data flow 45, signalling the video card 30 as appropriate, which again controls the monitor with signals 47 so as to cause the target document image to disappear, or to fill the main window, as appropriate.

Any computer program which operates in accordance with the invention may conveniently be written in either the Java or C++ object oriented programming languages, which can easily instantiate the behaviour of the objects shown in FIG. 6 and have excellent libraries of objects to enable the display of images or word processing documents within windows on a computer screen, and for the reading and processing of data in the XML format. However, although the invention has been described principally by reference to an object oriented programming language using XML, it will be immediately apparent that the invention is not limited either to the choice of programming language, or to the format of the data defining the infralinks between documents, but can be implemented by a procedural based computer programming language such as C, or by a procedural or semi-object oriented scripting language, such as Javascript or the macro languages provided with a word processing program. Further the data defining the infralinks between documents is not limited to being in the format of an extension to the XLink specification, nor in an XML format at all, but may be or any other suitable data format such as database or a proprietary format. Further as has already been explained, the infralinks from a source document may be stored in some external store such as a separate electronic file or database on the local, or a remote, machine; or alternatively may be stored within the same electronic file which is the source document itself.

A method and apparatus for displaying documents, especially document images, in a computer environment has therefore been disclosed. A first ‘source’ document is displayed in a first application window 2. Regions of the document that are referred to in a second ‘target’ document, or which refer to the second target document, are highlighted by an on screen indication such as a rectangular box 7. When a user moves an on-screen pointing device into the region 7, a second window 8 may be displayed showing the region of the target document which is referred to, or which refers to the source document. Thus, only the specific part of the target document that is relevant to the highlighted region of the first document is displayed. The method and apparatus therefore allow the user to view only those parts of a document image that are pertinent.

The preceding description of the preferred embodiments is purely illustrative, and it will be appreciated that modifications and variations thereto will present themselves to the skilled man within the scope of the invention which is defined in the claims.

1. A method of displaying one or more regions of one or more target documents which are referred to in, or refer to, at least one region of a source document, the method comprising (a) displaying the source document in a first window, (b) displaying at least one of the one or more target document regions in at least one second window when a pointer is within the said source document region, and (c) removing the displayed target document region or regions from the display when the pointer moves outside the said source document region.

2. A method of displaying one or more regions of one or more target documents which are referred to in, or refer to, at least one region of a source document, the method comprising (a) displaying the source document in a first window, (b) displaying at least one of the one or more target document regions in at least one second window when a pointer is within the said source document region, the second window or windows partly overlapping the source document region; and (c) removing the target document region from the display when the pointer moves outside the source document region and is outside the second window or windows.

3. A method of displaying one or more regions of one or more target documents which are referred to in, or refer to, at least one region of a source document, the method comprising (a) displaying the source document in a first window, (b) displaying a control means which appears or is activatable only when the pointer is within the said source document region; (c) if the control means is activated by the pointer, displaying at least one of the one or more target document regions in at least one second window.

4. A method according to claim 1 wherein a target document region is caused to replace the source document region in the first window when the second window is clicked with a pointing device.

5. A method according to claim 1 wherein there is displayed a list of text identifying the target document regions in the second, or in another, window, the elements of the list being responsive to a mouse click so as to cause the respective target document region to be displayed in the second window.

6. A method according to claim 5 wherein the said list includes text which describes the relationship between each respective target document region and the source document region.

7. A method according to claim 5 in which there is displayed one target document region in the second window and the said list of the other target document regions in the second, or in a third, window.

8. A method according to claim 3 wherein the control means is displayed in or immediately adjacent the source document region while the pointer is within the source document region and is removed from the display when the pointer moves outside the source document region and is outside the control means.

9. A method according to claim 3 wherein the control means is enabled while the pointer is within the source document region and is disabled when the pointer moves outside the source document region and is outside the control means.

10. A method according to claim 3 wherein the control means displays text which describes the relationship between the source document region and the target document region.
